(19) United States
(12) Patent Application Publication
(10) Pub. No.: US 2014/0284270 A1
(43) Pub. Date: Sep. 25, 2014

(54) RNA pores and methods and compositions for making and using same

(71) Applicants: George Fox, Manvel, TX (US); Quyen Tran, Houston, TX (US); Mario Rivas-Medrano, Del. Iztacalco (MX)

(72) Inventors: George Fox, Manvel, TX (US); Quyen Tran, Houston, TX (US); Mario Rivas-Medrano, Del. Iztacalco (MX)

(21) Appl. No.: 13/998,006

(22) Filed: Sep. 23, 2013

Related U.S. Application Data
(60) Provisional application No. 61/704,002, filed on Sep. 21, 2012.

(51) Int. Cl. B01D 71/74

(52) U.S. Cl. CPC B01D 71/74; B01D 2325/12; B01D 2323/36
USPC 210/502.1; 210/500.28; 536/23.1

(57) ABSTRACT

Synthetic RNA molecules having a pore, compositions including RNA molecules having a pore, where the compositions are capable of filtering metal ions, filtering molecular ions, performing size exclusion chromatography, performing ion specific chromatography, reversible metal ion and molecular ion binding, ion selective membranes, ion selective channels, ion selective/specific sensors, electrical conduits, battery components, etc., and devices and methods for making and using same. The RNAs used may be modified to improve stability. For example, by for example, a methyl group may be attached to the 2′ OH of the ribose.

The present application is a non-provisional application which claims benefit under 35 USC §119(e) of the U.S. Provisional Ser. No. 61/704,002 filed Sep. 21, 2012.

### FIELD OF THE INVENTION

Embodiments of the present invention relate to synthetic RNA molecules having a pore, compositions including RNA molecules having a pore, where the compositions are capable of filtering metal ions, filtering molecular ions, performing size exclusion chromatography, performing ion specific chromatography, reversible metal ion and molecular ion binding, ion selective membranes, ion selective channels, ion selective/specific sensors, electrical conduits, battery components, etc., and compositions and methods for making and using same. Embodiments of the present invention provide RNA molecules having at least one pore where the RNA molecule can catalyze reactions.

More particularly, embodiments of the present invention relate to compositions including RNA molecules having a pore, where the compositions are capable of filtering metal ions, filtering molecular ions, performing size exclusion chromatography, performing ion specific chromatography, reversible metal ion and molecular ion binding, ion selective membranes, ion selective channels, ion selective/specific sensors, etc., where the pores may be ion selective, size selective, reversible ion binder, ion selective or specific separators, size selective or specific separators, ion selective or specific sensors, size selective or specific sensors, ion conductors for electronic device such as batteries, and, compositions and methods for making and using same.

### DESCRIPTION OF THE RELATED ART

Many compositions and material are used for atom, ion, molecular, molecular ion, oligomer, oligomeric ion, polymer, or polymeric ion selective or specific devices including filters, channels, separators, membranes, sensors, reversible and non-reversible adsorbents or absorbent, etc. Many of these compositions are based on ceramic materials, nanostructures such as carbon nanotubes, and organic polymers. Nanopores are typically constructed from inorganic materials such as carbon nanotubes. Biological pores are typically associated with transport across membranes and comprised of pharmaceutical products for which the pore size is slightly smaller than the molecular size of the products.

The ribosome exit tunnel plays a key role in modem protein synthesis by allowing the nascent protein to leave the ribosome. The entrance to the tunnel is essentially a 1.5-2 nanometer pore, and the tunnel itself is in essence an RNA nanotube.

Thus, we believe that RNA molecular that include pores are suitable for use in the application disclosed above, without many of the drawback these other materials have in biological applications where environmental or health concerns are present.

### SUMMARY OF THE INVENTION

Embodiments of the present invention provide methods for preparing RNA molecules having at least one pore, where the method includes constructing a plasmid for expressing an RNA molecules having at least one pore, expressing the plasmid in a host organism, and collecting the RNA molecules having at least one pore. In certain embodiments, the synthetic RNA molecules include at least two pores.

Embodiments of the present invention provide synthetic RNA molecules having at least one pore. In certain embodiments, the synthetic RNA molecules include at least two pores.

Embodiments of the present invention provide synthetic RNA molecules having at least one pore. In certain embodiments, chemically modified RNAs including 2′-O-methyl RNA and others are used.

Embodiments of the present invention provide sensors including RNA molecules having at least one pore, where the pores are atom, ion, molecule, or molecular ion selective or specific.

Embodiments of the present invention provide size exclusion membranes including RNA molecules having at least one pore, where the pores are atom, ion, molecule, or molecular ion selective or specific.

Embodiments of the present invention provide semi-permeable membranes including RNA molecules having at least one pore, where the pores are atom, ion, molecule, or molecular ion selective or specific.

Embodiments of the present invention provide filters including RNA molecules having at least one pore, where the pores are atom, ion, molecule, or molecular ion selective or specific.

Embodiments of the present invention provide separators including RNA molecules having at least one pore, where the pores are atom, ion, molecule, or molecular ion selective or specific.

Embodiments of the present invention provide reversible or non-reversible absorbents or adsorbents including RNA molecules having at least one pore, where the pores are atom, ion, molecule, or molecular ion selective or specific.

Embodiments of the present invention provide electrical conduits including RNA molecules having at least one pore, where the pores conduct ions, molecular ions, and/or polymeric ions.

Embodiments of the present invention provide channels including RNA molecules having at least one pore, where the pores form atom, ion, molecule, or molecular ion selective or specific channels.

Embodiments of the present invention provide methods using the sensors, size exclusion membranes, semi-permeable membranes, conduits, channels, filters, separators, and/or reversible or non-reversible absorbents or adsorbents of this invention.

Embodiments of the present invention provide devices including the sensors, size exclusion membranes, semi-permeable membranes, electrical conduits, channels, filters, separators, and/or reversible or non-reversible absorbents or adsorbents of this invention.

Embodiments of the present invention provide arrays including RNA molecules having at least one pore, where the pores form atom, ion, molecule, or molecular ion selective or specific.

Embodiments of the present invention provide methods for using RNA molecules having at least one pore to concentrate an atom, ion, molecule, or molecular ion selectively or specifically.

Embodiments of the present invention provide RNA molecules having at least one pore where the RNA molecule can catalyze reactions.

### BRIEF DESCRIPTION OF THE DRAWINGS

The invention can be better understood with reference to the following detailed description together with the appended illustrative drawings in which like elements are numbered the same:

FIG. 1 depicts Thermus thermophilus small subunit ribosome RNA.

FIG. 2 depicts Thermus thermophilus large subunit ribosome RNA.

FIG. 3A depicts the location of a self-contained pore in 23S rRNA. The secondary structure of the 3′ half of the Thermus thermophilus 23S rRNA is shown with the RNA region that forms the pore highlighted.

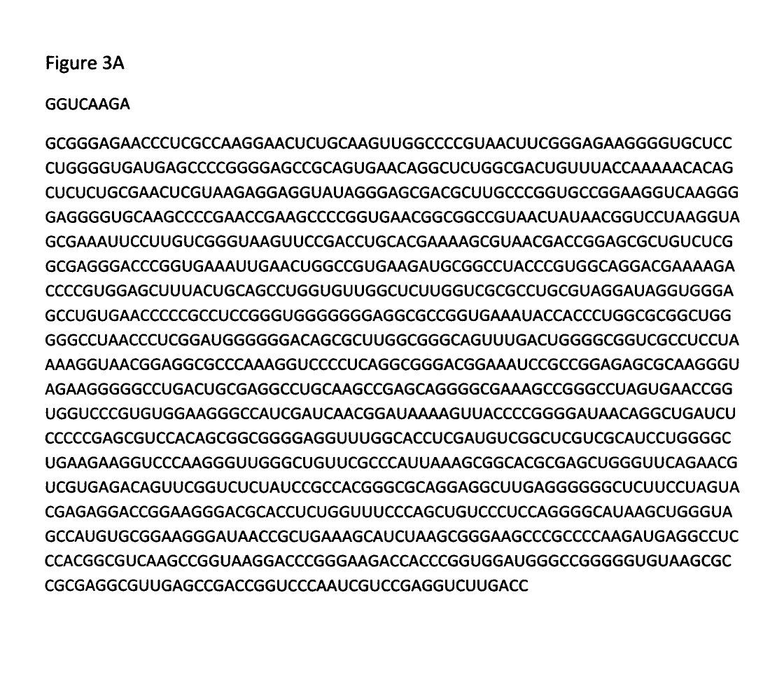

FIG. 3B depicts the atomic resolution structure (PDB 2WDK and 2WDL) of residues 2103-2186 of Domain V is shown in a space filling format. The aperture of the pore in the ribosome ranges from 11 Å to 15 Å and the residues producing the pore (green) are 2116-2119, 2134-2137, 2148-2155, 2159-2162 and 2172-2174.

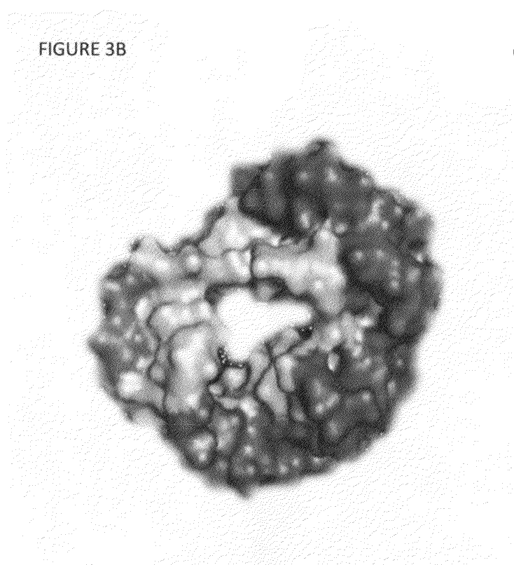

FIG. 4 depicts a map of pCR21-83mer plasmid.

FIG. 5 depicts an alignment of various pores and the pore lining residues are in each case listed as they occur 5′ to 3′ in the RNA. Dashes represent gap sizes & for long gaps the number of residues is shown. Underlined bases are involved in base pairing according to the Noller secondary structures.

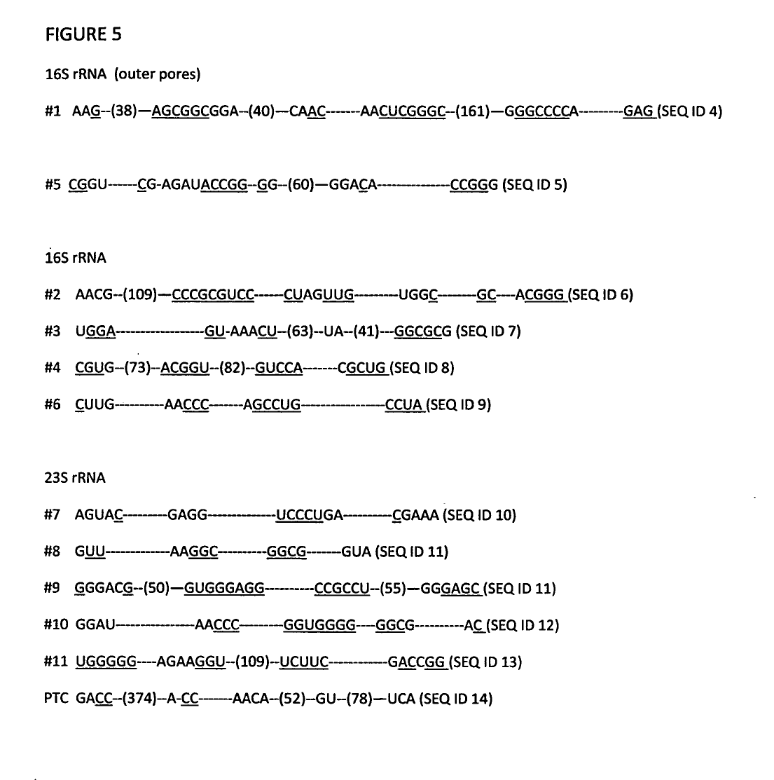

FIG. 6 depicts the sequence of the synthesized 83mer described in Example 1.

### DETAILED DESCRIPTION OF THE INVENTION

The inventors have found that RNA pores may be used to construct atom, ion, molecular, molecular ion, oligomer, oligomeric ion, polymer, or polymeric ion selective or specific channels, filters, separators, membranes, sensors, etc. or size selective or specific channels, filters, separators, membranes, etc.

Ribosomes are cellular machines that synthesize proteins according to the genetic code. A key functional component of the modem ribosome is an exit tunnel through which the newly synthesized protein passes in order to leave the ribosome. Although not generally referred to as such, the entrance to this exit tunnel is a pore that occurs in the RNA. The entrance to the tunnel is essentially a 1.5-2 nanometer pore, and the tunnel itself is in essence an RNA nanotube. This raises the question of whether pores are common in RNA and if so, how the RNA structure folds to form them. RNA pores may be associated with proteins including ribosomal proteins. Some proteins are associated with the pore either on the exterior portion of the pore or in some cases the protein can interact directly with the pore.

Atomic resolution structures can be visualized with Pymol (The PyMOL Molecular Graphics System, Version 1.5.0.4 Schrödinger, LLC.). The pore RNA chain is first represented as a Connolly surface through PyMOL's internal surfacing algorithm. This representation allows easy recognition of structural pores in the RNA. Once pores have been localized, ribbon and lines representations can be used to define the properties and nature of the pores.

Crystal structures of large RNAs (70 plus nucleotides) that have been deposited in the Protein Data Bank (PDB, are available. The crystal structures of ribosomes from Thermus thermophilus (PDB 2WDK and 2WDL) has been used to identify pores in the 16S rRNA and 23S rRNA. The extent to which these pores are conserved may be determined by examining structures of ribosomes from other species, e.g., Escherichia coli (PDB 3R8N, 3R8O, 3R8S and 3R8T), Haloarcula marismortui (PDB 1112), and Deinococcus radiodurans (PDB 2D3O). Other potential sources of RNA pores include riboswitches (PDB 2YDH, 3SUH and 2YIF), 4.5S RNA (PDB 1DUL and 1HQ1), RNAse-P (PDB 3Q1Q), and in the partial structure of a RNA spliceosome (PDB 3SIV).

Space filling representations of the crystal structures of the 16S ribosomal RNA and 23S ribosomal RNA found in Thermus thermophilus ribosomes were examined. These structures (PDB IDS 2WDK and 2WDL respectively) were solved at 3.50 Å of resolution by Voorhees et al. (Nat Struct Mol Biol. 2009 16: 528-533). As a result, additional pores, Table 1 have been identified.

TABLE 1
RNA Pores Found in the Crystal Structures of the T. Thermophilus
16S and 23S rRNAs. Residue Numbering Is Based on the
T. Thermophilus Primary Sequences.

| Pore | | Residues defining | Residue | Size | Protein |
|---|---|---|---|---|---|
| No. | RNA | the pore | Count | (Å) | Interaction |
| 1 | 16S | 60-62, 101-109, 150-153, | 36 | 15 to 21 | S20 |
| | | 161-169, 331-338, 348-350 | | | |
| 2 | 16S | 119-123, 233-241, 248-254, | 33 | 13 to 21 | S17 |
| | | 264-267, 276-277, 282-287 | | | |
| 3 | 16S | 405-408, 427-428, 430-434, | 19 | 15 to 19 | S4 |
| | | 498-499, 541-546 | | | |
| 4 | 16S | 578-581, 655-659, 742-746, | 19 | 10 to 15 | S15 |
| | | 754-758 | | | |
| 5 | 16S | 689-692, 699-700, 702-710, | 28 | 9 to 13 | S11 |
| | | 713-714, 775-780, 796-800 | | | |
| 6 | 16S | 990-993, 1004-1008, | 19 | 11 to 18 | None |
| | | 1016-1021, 1038-1041 | | | |
| 7 | 23S | 203-207, 217-220, | 21 | 16 to 18 | L15, L28, |
| | | 235-242, 253-257 | | | L34, L35 |
| 8 | 23S | 1197-1199, 1213-1217, | 15 | 10 to 16 | L20, L4, |
| | | 1228-1231, 1239-1241 | | | L21 |
| 9 | 23S | 1424-1429, 1480-1487, | 26 | 7 to 14 | L2 |
| | | 1498-1503, 1559-1564 | | | |
| 10 | 23S | 2115-2118, 2134-2138, | 22 | 10 to 15 | None |
| | | 2148-2154, 2159-2162, | | | |
| | | 2173-2174 | | | |
| 11 | 23S | 2522-2526, 2531-2537, | 23 | 9 to 15 | L6, L36 |
| | | 2647-2651, 2664-2669 | | | |
| PTC | 23S | 2061-2064, 2439, | 15 | 10 to 17 | None |
| | | 2441-2442, 2450-2452, | | | |
| | | 2505-2506, 2585-2587 | | | |

Table 2 lists pores that are present in non-rRNA molecules such as riboswitches or ribozymes, including the residues that form the pores. No pores have been found in the 4.5S RNA or snRNA structures that were examined. This demonstrates that all large RNAs do not necessarily contain pores. An interesting case among these examples is pore number 6 that is part of a ribozyme. In this case some of the bases that line the pore (the catalytic ones) are actually exposed to the center of the pore.

TABLE 2
RNA Pores Found in Non-Ribosomal RNAs

| | PDB | RNA | | Size |
|---|---|---|---|---|
| # | ID | Type | Residues defining the Pore | (Å) |
| 1 | 2YDH | Riboswitch | Chain A13, 22-23, 37-40, 60-62 | 7-17 |
| 2 | 2YIF | Riboswitch | Chain X: 10-13 Chain Z: 95-103 | 10-16 |
| 3 | 1Y27 | Riboswitch | 23-30, 38-42, 53-56, 66-71 | 7-12 |
| 4 | 1Y26 | Riboswitch | 25-29, 37-42, 53-58, 66-69 | 7-11 |
| 5 | 2OIU | Ribozyme | Chain P: 49-54, 63-69 Chain Q: | 10-15 |
| | | | 48-54, 63-69 | |
| 6 | 2OIU | Ribozyme | Chain Q: 1-5, 17-21, 38-47 | 9-20 |
| 7 | 2Y0Q | Ribozyme | 144-148, 192-195, 219-222, | 7-11 |
| | | | 232-236 | |
| 8 | 3DHS | RNAse-P | Chain A 60-64, 77-80, 258-260, | 5-17 |
| | | | 288-290, 297-299 | |
| 9 | 3Q1Q | RNAse-P | Chain A: 72-74, 102-105, 181-193 | 17-18 |
| 10 | 3Q1Q | RNAse-P | Chain B: 223-226, 240-243, | 10-18 |
| | | | 257-263 Chain C: 83-86 | |
| 11 | 3Q1R | RNAse-P | Chain B: 60-62, 223-226, 240-243, | 11-19 |
| | | | 257-263 Chain C: 80-86 | |

A careful comparison of the various RNA pores seen to date, suggests that there are at least two architectures. The more common type is a phosphate lined pore made essentially by the phosphodiester backbone of the RNA. Such pores will be negatively charged. In this example the natural trajectory of one strand of an A-form duplex forms one portion of the pore which is then completed by additional neighboring residues. The second type is exemplified by the single case of the entrance to the ribosomal exit tunnel. In this example, the pore is lined by the nucleic acid bases rather than the RNA backbone. In contrast, pores of this type this will present a slightly hydrophobic or positively charged surface, depending on the hydration and protonation state of the bases in the solvent. In all the other pores there is always at least one major stem of at least 4-5 base pairs that the pore is built around. If one looks down an A′ form helix one sees something that partially resembles a pore. The additional residues combine with the “nucleation” RNA segment to create the pore.

In both cases, we have found that the pores are sub nanometer in size with pore size ranging from 7 Å-15 Å, (i.e., 0.7 nm-1.5 nm). It is of potential interest that small proteins such as ribosomal protein S4 can interact directly with the pores.

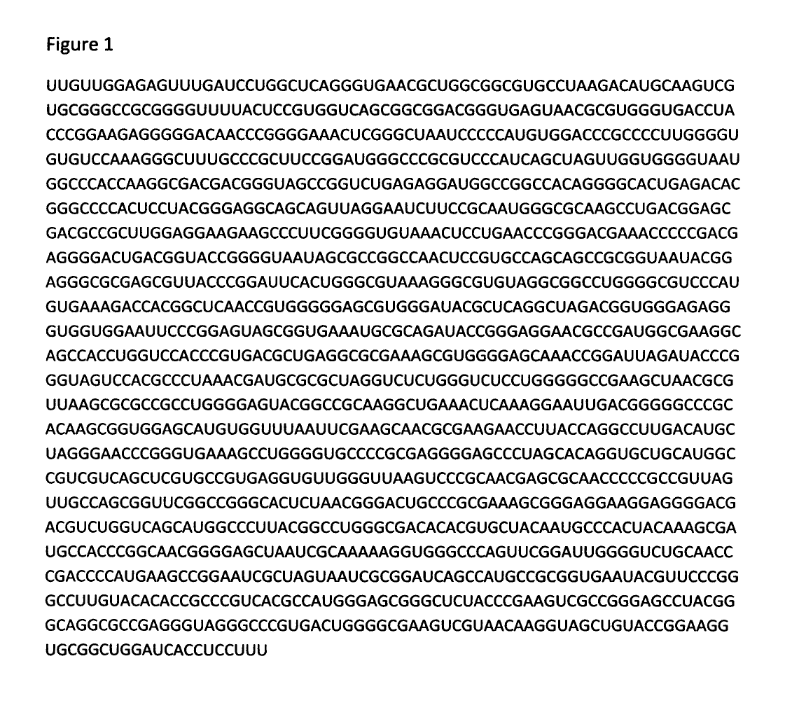

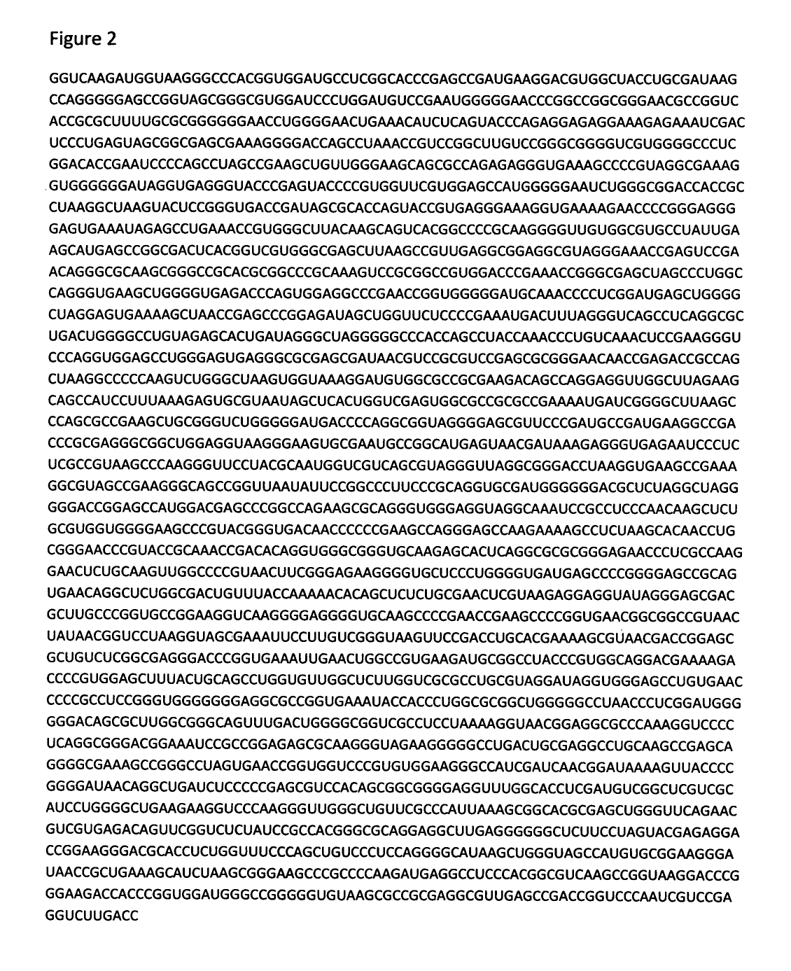

Most of the pores seen to date are in the larger context of the structure of the entire ribosomal RNA. Thus, it is possible that the pore is formed in part by tertiary interactions with other parts of the ribosomal RNA and hence might cease to exist in the absence of such interactions. However, most of the pores that have been found are the result of the folding of either contiguous region of RNA or the compactification of several helixes and hence this unlikely to be a It nevertheless is of general interest then that one pore (number 10 in Table 1) is located in a region of the larger structure that is devoid of such interactions, implying that it is a “self-contained” pore problem (Tishchenko et al, High Resolution Crystal Structure of the Isolated L1 Stalk, Acta Crystallogr D Biol Crystallogr. 2012 August; 68 (Pt 8):1051-7). In addition, this example is formed from just 83 residues as opposed to the exit tunnel pore, which is approximately 250 residues. From a practical perspective RNA pores of the size range encountered may be useful in the filtration of metal ions, molecular ions (such as ammonium ions, sulfates, phosphates, etc.). RNA pores may also be useful in the filtration of pharmaceutical products for which the pore size is slightly smaller than the molecular size of the products. Relative to carbon nanopores, they would offer the advantage of being non-toxic. RNA pores may, however, be subject to enzymatic degradation. Hence, in practical applications, we propose synthesizing 2′-O-methyl RNA, which is far less sensitive to such degradation. Such RNA could be synthesized with 2′-O-methyl nucleotides. Each nucleotide need not be 2′-O-methyl and in certain applications a mixture of 2′-O-methyl and non-2′-O-methyl nucleotides may be included in the RNA molecules. FIGS. 1 and 2 show Thermus thermophilus small subunit ribosome RNA and large subunit ribosome RNA, respectively.

A pore forming architecture can be duplicated multiple times in a larger RNA by design of the primary sequence. In solution, such an RNA forms many pores all connected and arrayed in a net like macro-structure. This net-like structure should have a distribution of regular small and large pores through which filtrates can flow and that the tessellation and stacking of such net-like structures might create a molecular sieve that could have properties far superior to those of ceramic and membrane variants.

To illustrate, pore number 10 in Table 1 is in fact created by a small well defined section of RNA consisting of approximately 83 residues. Such a section of RNA can be synthesized by a variety of recombinant techniques to obtain an RNA molecule containing a pore (See Example 1). Thus, an RNA molecule containing one or more pores may be obtained by synthesizing RNAs with the following motif:

Pore-Sequence-1-(N)ₙ-Pore-Sequence-2-(N)ₙ-

Pore-Sequence3-(N)ₙ-Pore-Sequence-4 etc etc

where N is a nucleotide and n is from between 1 and 100 or from 1 to 50 or from 1 to 30 or from 1 to 25 or from 1 to 20 or from 1 to 15 or from 1 to 10 or from 1 to 9 or from 1 to 8 or from 1 to 7 or from 1 to 6 or from 1 to 5 or from 1 to 4 or from 1 to 3 or from 2 to 50 or from 2 to 30 or from 2 to 25 or from 2 to 20 or from 2 to 15 or from 2 to 10 or from 2 to 9 or from 2 to 8 or from 2 to 7 or from 2 to 6 or from 2 to 5 or from 2 to 4 or from 3 to 50 or from 3 to 30 or from 3 to 25 or from 3 to 20 or from 3 to 15 or from 3 to 10 or from 3 to 9 or from 3 to 8 or from 3 to 7 or from 3 to 6 or from 3 to 5 or from 4 to 50 or from 4 to 30 or from 4 to 25 or from 4 to 20 or from 4 to 15 or from 4 to 10 or from 4 to 9 or from 4 to 8 or from 4 to 7 or from 4 to 6 or from 5 to 50 or from 5 to 30 or from 5 to 25 or from 5 to 20 or from 5 to 15 or from 5 to 10. The number of pores may be dictated by the application. The number of pores may be from between 1 to 10,000,000 or from 1 to 5,000,000 or from 1 to 3,000,000 or from 1 to 2,500,000 or from 1 to 2,000,000 or from 1 to 1,500,000 or from 1 to 1,000,000 or from 1 to 900,000 or from 1 to 800,000 or from 1 to 700,000 or from 1 to 600,000 or from 1 to 500,000 or from 1 to 400,000 or from 1 to 300,000 or from 1 to 200,000 or from 1 to 100,000 or from 1 to 50,000 or from 1 to 25,000 or from 1 to 20,000 or from 100 to 10,000,000 or from 100 to 5,000,000 or from 100 to 3,000,000 or from 100 to 2,500,000 or from 100 to 2,000,000 or from 100 to 1,500,000 or from 100 to 1,000,000 or from 100 to 900,000 or from 100 to 800,000 or from 100 to 700,000 or from 100 to 600,000 or from 100 to 500,000 or from 100 to 400,000 or from 100 to 300,000 or from 100 to 200,000 or from 100 to 100,000 or from 100 to 50,000 or from 100 to 25,000 or from 100 to 20,000 or from 1000 to 10,000,000 or from 1000 to 5,000,000 or from 1000 to 3,000,000 or from 1000 to 2,500,000 or from 1000 to 2,000,000 or from 1000 to 1,500,000 or from 1000 to 1,000,000 or from 1000 to 900,000 or from 1000 to 800,000 or from 1000 to 700,000 or from 1000 to 600,000 or from 1000 to 500,000 or from 1000 to 400,000 or from 1000 to 300,000 or from 1000 to 200,000 or from 1000 to 100,000 or from 1000 to 50,000 or from 1000 to 25,000 or from 1000 to 20,000 or from 1 to 10,000 or from 1 to 5,000 or from 1 to 3,000 or from 1 to 2,500 or from 1 to 2,000 or from 1 to 1,500 or from 1 to 1,000 or from 1 to 900 or from 1 to 800 or from 1 to 700 or from 1 to 600 or from 1 to 500 or from 1 to 400 or from 1 to 300 or from 1 to 200 or from 1 to 100 or from 1 to 75 or from 1 to 50 or from 1 to 25 or from 1 to 10 or from 5 to 10,000 or from 5 to 5,000 or from 5 to 3,000 or from 5 to 2,500 or from 5 to 2,000 or from 5 to 1,500 or from 5 to 1,000 or from 5 to 900 or from 5 to 800 or from 5 to 700 or from 5 to 600 or from 5 to 500 or from 5 to 400 or from 5 to 300 or from 5 to 200 or from 5 to 100 or from 5 to 75 or from 5 to 50 or from 5 to 25 or from 5 to 10 or from 10 to 10,000 or from 10 to 5,000 or from 10 to 3,000 or from 10 to 2,500 or from 10 to 2,000 or from 10 to 1,500 or from 10 to 1,000 or from 10 to 900 or from 10 to 800 or from 10 to 700 or from 10 to 600 or from 10 to 500 or from 10 to 400 or from 10 to 300 or from 10 to 200 or from 10 to 100 or from 10 to 75 or from 10 to 50 or from 10 to 25 or from 20 to 10,000 or from 20 to 5,000 or from 20 to 3,000 or from 20 to 2,500 or from 20 to 2,000 or from 20 to 1,500 or from 20 to 1,000 or from 20 to 900 or from 20 to 800 or from 20 to 700 or from 20 to 600 or from 20 to 500 or from 20 to 400 or from 20 to 300 or from 20 to 200 or from 20 to 100 or from 20 to 75 or from 20 to 50 or from 50 and 10,000 or from 50 to 5,000 or from 50 to 3,000 or from 50 to 2,500 or from 50 to 2,000 or from 50 to 1,500 or from 50 to 1,000 or from 50 to 900 or from 50 to 800 or from 50 to 700 or from 50 to 600 or from 50 to 500 or from 50 to 400 or from 50 to 300 or from 50 to 200 or from 50 to 100 or from 50 to 75.
One example is listed below:

Pore-Sequence-1-UUUUUUUU-Pore-Sequence-2-UUUUUUUU-

Pore-Sequence3-UUUUUUU-Pore-Sequence-4 etc etc

Therefore, it is possible to create a single RNA with many identical pores or alternatively a single RNA with pores of different types. The spacer shown as a stretch of uridine or other residues would be designed of an appropriate length to separate the individual pores while being long enough to prevent unwanted interactions between the individual copies of the pore forming sequence. Alternatively RNAs containing single pores could be produced in large quantities and perhaps embedded into a resin or attached to the surface as in typical hybridization arrays.
In addition, in some cases the crystal structure reveals that a pore is being occupied by a ribosomal protein.

The RNA pore structures of the present invention may also be used for performing catalytic reactions. The pore at the ribosomal peptidyl transferase center is involved in protein synthesis, possibly by facilitating subsequent steps of peptide bond formation if not the actual peptide bond formation. Also, a pore is actively involved in the catalysis performed by the L1 ligase which is actually an artificial RNA that was selected to have catalytic activity. RNA can be constructed that contains one or more pores and then using selection to try to obtain a target catalytic activity by mutating the RNA. Such catalytic activity may include reductase, transferase, hydrolase, lyase, isomerase and ligase activity.

Naturally occurring pores may be altered such that they permit catalytic reactions. Alternatively, non-naturally occurring pores can be constructed to perform catalysis. Where the ligand of the pore is not known or the pore does not have a natural ligand the pore could use it as a scaffold to select for a pore that has ligands. A ligand or a group of ligands with similar properties could be selected. For example, being that pore 10 is close to the E-site tRNA and may interact with the CCA of this tRNA, one of the ligands could be CCA. A group of ligand can be created from CCA using adenosine analog or change adenosine for another base such as uridine, inosine, or guanine. For each change, another group of ligand having one or two amino acid linked via 3′-amide bond instead of the normal 3′-ester bond could be made. Prior to the selection procedure, the base affinity of each ligand for the unmodified pore would be measured. This could be done via quantitative affinity chromatography where the ligand is immobilized on beads and we measure the bound versus unbound fraction of the pore. Elution could be performed with a fix concentration of a denaturant such as foramide. Once base affinity for each ligand is known, a pore that binds with stronger affinity can be designed. It is preferable to maintain the overall shape of the pore, which means that limited perturbation to residues that line the pore is preferable. For pore 10, this is 20-22 nucleotides and current synthesis should be able to access this sequence space. A pool of pores would be synthesized where on average each pore variant is at least 1000× enriched. The ligands would then be immobilized to wells in a plate and known dilution of the pool of pores would be loaded into each well. After an incubation period, excess volume will be removed then the ligand will be stripped of the pores by different concentration of denaturants. The collection of elution fractions will be amplified via PCR and a subset would be run on a gel to see which fraction has some bound pores. Pores in fraction with the highest concentration of denaturants are of high interests and these will be sent for sequencing. The sequencing should allow one to classify pore as nonspecific binders and specific binders. Further affinity study could be performed on the specific binders where nuclear base analogue could be used to further improve the specificity.

The RNA molecules of the present invention may be used in solution or may be attached to a solid support or semi-permeable membrane. The support or membrane may be made of a variety of materials depending on the particular application. Support or membranes may be comprised of beads, glass slides, metal surfaces, surfaces coated with antibodies, surfaces coated with cells, hydrogel surfaces, nitrocellulose surfaces, polymeric surfaces, plastic surfaces, ceramic surfaces silicon dioxide surfaces and surfaces coated with proteins, peptides, amino acids, carbohydrates and/or nucleic acids. A variety of surface types (coated, charged, absorbing, non-absorbing, etc.) and surface configurations (flat, curved, bead, indented, etc.) may be employed. The RNA molecules could be embedded or covalently or non-covalently attached to the solid support or semi-permeable membranes.

The RNA molecules of the present invention can also be associated or covalently attached to other molecules such as proteins, carbohydrates, nucleic acids or other organic or biological molecules. For example the RNAs containing these pores could be coupled with other RNAs (e.g. riboswitches etc.) which serve as building blocks of more complex systems.

Software may be used to identify likely RNA pores but is not required for practical application of what has been discovered.

### EXAMPLE 1

### Synthesis of RNAs Containing Pores

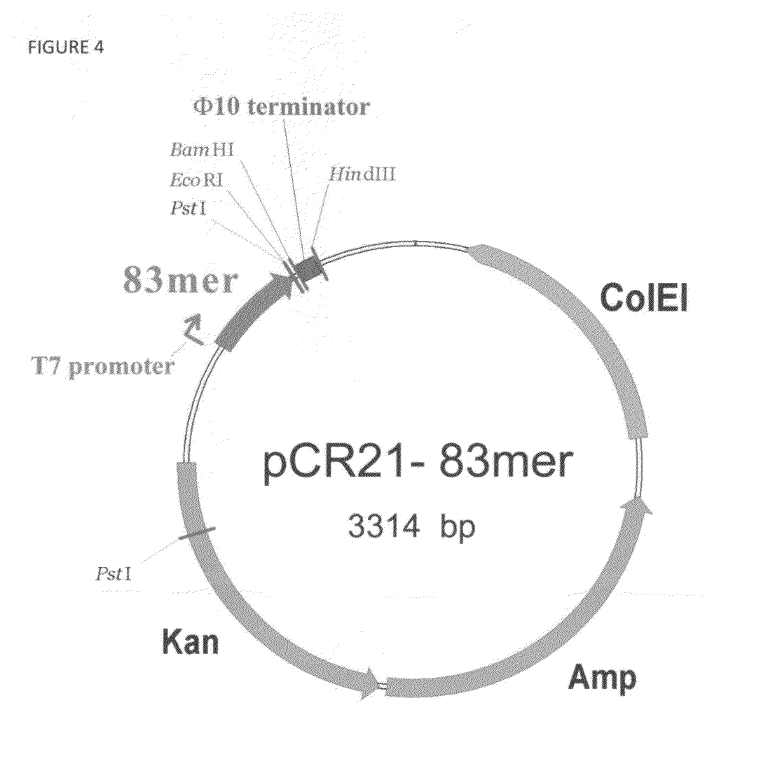

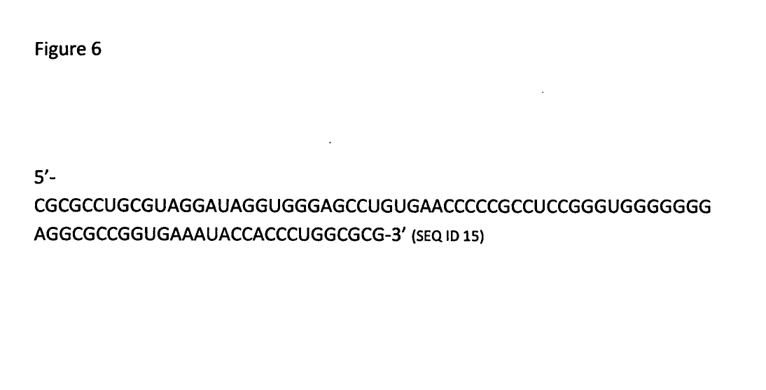

Quantities of the 83-mer RNA (sequence in FIG. 6) that comprises the 23S rRNA pore of FIG. 1 were obtained in the following manner. A DNA comprising an 83-mer and a T7 promoter were assembled by PCR from overlapping smaller DNA oligomers. The construct was subcloned into pCR21-T7ter plasmid upstream of Φ10 terminator sequence from phage T7. The plasmid was be propagated in Escherichia coli XL1Blue strain (Stratagene). The final construct is shown in FIG. 4.

An in vivo production procedure was utilized. The pCR21-83mer plasmid was transformed into Escherichia coli BLR(DE3) cells, which carry T7 RNA polymerase gene in their genomic DNA. Induction of T7 RNA polymerase allowed expression with IPTG provided the enzyme for intracellular 83mer RNA synthesis. The 83-mer RNA was synthesized by run off transcription with a single band detected on an acrylamide gel. The RNA was examined by circular dichroism (CD over a 4 day period. The RNA was dissolved in 10 mM phosphate buffer pH 6.5 at a final concentration of 0.02 mg/mL. CD of RNA was obtained between 230-300 nm at 25 C. This scanning was done three times. Further scanning between 200-230 nm was done twice. This second step was done to get a good average of the shorter wave length. The data collected was used as a base line to compare all further scans. The RNA solution was left in cuvette in the device overnight.

The CD of the RNA solution was obtained again between 200-300 nm at 25 C prior to titration with MgCl2 salt. The final MgCl2 salt concentration was 20 mM and was titrated using a 1 M MgCl2 stock. For each titration, 5 uL of stock was added so a total of ten titration steps were performed. The initial volume of the RNA was 2.5 mL. The titration was done at 25 C. No change was detected to CD profile subsequent to each titration step. The RNA solution was left in cuvette overnight.

The CD of RNA solution was obtained again between 200-300 nm at 25 C prior to melting temperature determination. CDs of the RNA were obtained three times at 75 C and 85 C. The RNA was assumed to have melted at 85 C. The cuvette was kept at set temperature for 10 minute before the CD was taken to allow for equilibration. The CD showed that the maximum was lowered by 2 millidegrees at 75 C and 85 C but the wavelength maximum did not change appreciably. The absorption maximum remained around 264-267 nm. The RNA solution was left in cuvette overnight.

High resolution CDs of RNA solution was obtained between 255-275 at 35 C, 45 C, 50 C, 55 C, 60 C, 65 C, 70 C, 75 C, 80 C, and 85 C. Scans were done in triplicate and averaged. The CD spectra maximum was determined to be at 264 nm and a melt profile was graphed using CDs at that wavelength for each measured temperature. The resulting melt profile looked to be very linear.

Overall, the CD experiments indicate that the RNA is very stable. The same RNA solution was used over the course of four days with multiple heating and cooling cycles during the last two days and showed very little change in the CD spectra. The MgCl₂ titration during day 2 suggested that the RNA is insensitive to Mg⁺⁺ ion concentration. The melting profile also showed that the RNA is also insensitive to temperature.

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

1-7. (canceled)

8. A filter comprising one or more RNA molecules having at least one pore wherein the RNA molecule(s) are attached to a support.

9. The filter of claim 8 wherein the support is a selected from the group consisting of a film, beads, glass slides, metal surfaces, surfaces coated with antibodies, surfaces coated with cells, hydrogel surfaces, nitrocellulose surfaces, polymeric surfaces, plastic surfaces, ceramic surfaces silicon dioxide surfaces and surfaces coated with proteins, peptides, amino acids, carbohydrates and/or nucleic acids.

10-17. (canceled)

18. The RNA molecule of claim 8 wherein the molecule has catalytic activity.

19. The RNA molecule of claim 18 wherein the molecule has catalytic activity selected from the activities consisting of reductase, transferase, hydrolase, lyase, isomerase and ligase activity.

20. The RNA molecule of claim 8 wherein the molecule contains from 1 to 10,000 pores.

21. The RNA molecule of claim 8 wherein the molecule contains from 10 to 10,000 pores.


SEQUENCE LISTING (15 sequences)

SEQ ID NO: 1 - RNA, 1522 nt, Thermus thermophilus
uuuguuggagaguuugauccuggcucagggugaacgcuggcggcgugccuaagacaugcaagucgugcgggccgcgggguuuuacuccguggucagcggcggacgggugaguaacgcgugggugaccuacccggaagagggggacaacccggggaaacucgggcuaaucccccauguggacccgccccuugggguguguccaaagggcuuugcccgcuuccggaugggcccgcgucccaucagcuaguuggugggguaauggcccaccaaggcgacgacggguagccggucugagaggauggccggccacaggggcacugagacacgggccccacuccuacgggaggcagcaguuaggaaucuuccgcaaugggcgcaagccugacggagcgacgccgcuuggaggaagaagcccuucgggguguaaacuccugaacccgggacgaaacccccgacgaggggacugacgguaccgggguaauagcgccggccaacuccgugccagcagccgcgguaauacggagggcgcgagcguuacccggauucacugggcguaaagggcguguaggcggccuggggcgucccaugugaaagaccacggcucaaccgugggggagcgugggauacgcucaggcuagacggugggagagggugguggaauucccggaguagcggugaaaugcgcagauaccgggaggaacgccgauggcgaaggcagccaccugguccacccgugacgcugaggcgcgaaagcguggggagcaaaccggauuagauacccggguaguccacgcccuaaacgaugcgcgcuaggucucugggucuccugggggccgaagcuaacgcguuaagcgcgccgccuggggaguacggccgcaaggcugaaacucaaaggaauugacgggggcccgcacaagcgguggagcaugugguuuaauucgaagcaacgcgaagaaccuuaccaggccuugacaugcuagggaacccgggugaaagccuggggugccccgcgaggggagcccuagcacaggugcugcauggccgucgucagcucgugccgugagguguuggguuaagucccgcaacgagcgcaacccccgccguuaguugccagcgguucggccgggcacucuaacgggacugcccgcgaaagcgggaggaaggaggggacgacgucuggucagcauggcccuuacggccugggcgacacacgugcuacaaugcccacuacaaagcgaugccacccggcaacggggagcuaaucgcaaaaaggugggcccaguucggauuggggucugcaacccgaccccaugaagccggaaucgcuaguaaucgcggaucagccaugccgcggugaauacguucccgggccuuguacacaccgcccgucacgccaugggagcgggcucuacccgaagucgccgggagccuacgggcaggcgccgaggguagggcccgugacuggggcgaagucguaacaagguagcuguaccggaaggugcggcuggaucaccuccuuucu

SEQ ID NO: 2 - RNA, 2822 nt, Thermus thermophilus
ggucaagaugguaagggcccacgguggaugccucggcacccgagccgaugaaggacguggcuaccugcgauaagccagggggagccgguagcgggcguggaucccuggauguccgaaugggggaacccggccggcgggaacgccggucaccgcgcuugcgcggggggaaccuggggaacugaaacaucucaguacccagaggagaggaaagagaaaucgacucccugaguagcggcgagcgaaaggggaccagccuaaaccguccggcuuguccgggcggggucgggggcccucggccgaauccccagccuagccgaagcuguugggaagcagcgccagagagggugaaagccccguaggcgaaagguggggggauaggugaggguacccgaguaccccgugguucguggagccaugggggaaucugggcggaccaccgccuaaggcuaaguacuccgggugaccgauagcgcaccaguaccgugagggaaaggugaaaagaaccccgggaggggagugaaauagagccugaaaccgugggcuuacaagcagucacggccccaagggguuguggcgugccuauugaagcaugagccggcgacucacggucgugggcgagcuuaagccguugaggcggaggcguagggaaaccgaguccgaacagggcgcguccgcggccguggacccgaaaccgggcgagcuagcccuggccagggugaagcuggggugagacccaguggaggcccgaaccggugggggaugcaaaccccucggaugagcuggggcuaggagugaaaagcuaaccgagcccggagauagcugguucuccccgaaaugacuuuagggucagccucaggcgcugacuggggccuguagagcacugauagggcuagggggcccaccagccuaccaaacccugucaaacuccgaagggucccagguggagccugggagugagggcgcgagcgauaacguccgcguccgagcgcgggaacaaccgagaccgccagcuaaggcccccaagucugggcuaagugguaaaggauguggcgccgcgaagacagccagucgaguggcgccgcgccgaaaaugaucggggcuuaagcccagcgccgaagcugcgggucugggggaugaccccaggcgguaggggagcguucccgaugccgaugaaggccgacccgcgagggcggcuggagguaagggaagugcgaaugccggcaugaguaacgauaaagagggugagaaucccucucgccguaagcccaaggguuccuacgcaauggucgucagcguaggguuaggcgggaccuaaggugaagccgaaaggcguagccgaagggcagccgguuaauauuccggcccuucccgcaggugcgauggggggacgcucuaggcuagggggaccggagccauggacgagcccggccagaagcgcagggugggagguaggcaaauccgccucccaacaagcucugcgugguggggaagcccgcaaccccccgaagccagggagccaagaaaagccucuaagcacaaccugcgggaacccguaccgcaaaccgacacaggugggcgggugcaagagcacucaggcgcgcgggagaacccucgccaaggaacucugcaaguuggccccguaacuucgggagaaggggugcucccuggggugaugagccccggggagccgcagugaacaggcucuggcgacuguuuaccaaaaacacagcucucugcgaacucguaagaggagguauagggagcgacgcuugcccggugccggaaggucaaggggaggggugcaagccccgaaccgaagccccggugaacggcggccguaacuauaacgguccuaagguagcgaaauuccuugucggguaaguuccgaccugcacgaaaagcguaacgaccggagcgcugucucggcgagggacccggugaaauugaacuggccgugaagaugcggccuacccguggcaggacgaaaagaccccguggagcuuuacugcagccugguguuggcucuuggucgcgccugcguaggauaggugggagccugugaacccccgccuccgggugggggggaggcgccggugaaauaccacccuggcgcggcugggggccuaacccucggauggggggacagcgcuuggcgggcaguuugacuggggcggucgccuccuaaaagguaacggaggcgcccaaagguccccucaggcgggacggaaauccgccggagagcgcaaggguagaagggggccugacugcgaggccugcaagccgagcaggggcgaaagccgggccuagugaaccgguggucccguguggaagggccaucgaucaacggauaaaaguuaccccggggauaacaggcugaucucccccgagcguccacagcggcggggagguuuggcaccucgaugucggcucgucgcauccuggggcugaagaaggucccaaggguugggcuguucgcccauuaaagcggcacgcgagcuggguucagaacgucgugagacaguucggucucuauccgccacgggcgcaggaggcuugaggggggcucuuccuaguacgagaggaccggaagggacgcaccucugguuucccagcugucccuccaggggcauaagcuggguagccaugugcggaagggauaaccgcugaaagcaucuaagcgggaagcccgccccaagaugaggccucccacggcgucaagccgguaaggacccgggaagaccacccgguggaugggccggggguguaagcgccgcgaggcguugagccgaccggucccaaucguccgaggucuugaccccucc

SEQ ID NO: 3 - RNA, 1182 nt, Thermus thermophilus
uaacuucgggagaaggggugcucccuggggugaugagccccggggagccgcagugaacaggcucuggcgacuguuuaccaaaaacacagcucucugcgaacucguaagaggagguauagggagcgacgcuugcccggugccggaaggucaaggggaggggugcaagccccgaaccgaagccccggugaacggcggccguaacuauaacgguccuaagguagcgaaauuccuugucggguaaguuccgaccugcacgaaaagcguaacgaccggagcgcugucucggcgagggacccggugaaauugaacuggccgugaagaugcggccuacccguggcaggacgaaaagaccccguggagcuuuacugcagccugguguuggcucuuggucgcgccugcguaggauaggugggagccugugaacccccgccuccgggugggggggaggcgccggugaaauaccacccuggcgcggcugggggccuaacccucggauggggggacagcgcuuggcgggcaguuugacuggggcggucgccuccuaaaagguaacggaggcgcccaaagguccccucaggcgggacggaaauccgccggagagcgcaaggguagaagggggccugacugcgaggccugcaagccgagcaggggcgaaagccgggccuagugaaccgguggucccguguggaagggccaucgaucaacggauaaaaguuaccccggggauaacaggcugaucucccccgagcguccacagcggcggggagguuuggcaccucgaugucggcucgucgcauccuggggcugaagaaggucccaaggguugggcuguucgcccauuaaagcggcacgcgagcuggguucagaacgucgugagacaguucggucucuauccgccacgggcgcaggaggcuugaggggggcucuuccuaguacgagaggaccggaagggacgcaccucugguuucccagcugucccuccaggggcauaagcuggguagccaugugcggaagggauaaccgcugaaagcaucuaagcgggaagcccgccccaagaugaggccucccacggcgucaagccgguaaggacccgggaagaccacccgguggaugggccggggguguaagcgccgcgaggcguugagccgaccggucccaaucguccgaggucuugaccccucc

SEQ ID NO: 4 - RNA, 36 nt, Thermus thermophilus
aagagcggcggacaacaacucgggcgggccccagag

SEQ ID NO: 5 - RNA, 27 nt, Thermus thermophilus
cggucgagauaccggggggacaccggg

SEQ ID NO: 6 - RNA, 31 nt, Thermus thermophilus
aacgcccgcgucccuaguuguggcgcacggg

SEQ ID NO: 7 - RNA, 19 nt, Thermus thermophilus
uggaguaaacuuaggcgcg

SEQ ID NO: 8 - RNA, 19 nt, Thermus thermophilus
cgugacgguguccacgcug

SEQ ID NO: 9 - RNA, 19 nt, Thermus thermophilus
cuugaacccagccugccua

SEQ ID NO: 10 - RNA, 21 nt, Thermus thermophilus
aguacgaggucccugacgaaa

SEQ ID NO: 11 - RNA, 15 nt, Thermus thermophilus
guuaaggcggcggua

SEQ ID NO: 12 - RNA, 22 nt, Thermus thermophilus
ggauaacccgguggggggcgac

SEQ ID NO: 13 - RNA, 24 nt, Thermus thermophilus
ugggggagaagguucuucgaccgg

SEQ ID NO: 14 - RNA, 16 nt, Thermus thermophilus
gaccaccaacaguuca

SEQ ID NO: 15 - RNA, 84 nt, Thermus thermophilus
cgcgccugcguaggauaggugggagccugugaacccccgccuccgggugggggggaggcgccggugaaauaccacccuggcgcg